(19) United States
(12) Patent Application Publication
(10) Pub. No.: US 2005/0049868 A1
(43) Pub. Date: Mar. 3, 2005

(54) Speech recognition error identification method and system

(75) Inventor: Senis Busayapongchai, Tucker, GA (US)

Correspondence Address: MERCHANT & GOULD PC, P.O. BOX 2903, MINNEAPOLIS, MN, 55402-0903, US

(73) Assignee: BellSouth Intellectual Property Corporation

(21) Appl. No.: 10/647,709

(22) Filed: Aug. 25, 2003

(51) Int. Cl. G10L 15/04

(52) U.S. Cl. 704/251

(57) ABSTRACT

Methods and systems are provided for testing and improving the performance of a speech recognition system. Words, phrases or utterances are assembled for recognition by one or more speech recognition engines. At a text-to-speech application, an audio pronunciation of each word, phrase or utterance is created. Each audio pronunciation is passed to one or more speech recognition engines. The speech recognition engine analyzes the audio pronunciations and derives one or more words, phrases or utterances from the audio pronunciations. A confidence score is assigned to each of the one or more words, phrases or utterances derived from the audio pronunciations. If the confidence score for any derived word, phrase or utterance is below an acceptable threshold, the results of the speech recognition engine for the word, phrase or utterance are passed to a developer to allow the developer to take corrective action with respect to the speech recognition engine.

### FIELD OF THE INVENTION

The present invention generally relates to systems and methods for recognizing and processing human speech. More particularly, the present invention relates to correction of erroneous speech recognition by a speech recognition engine.

### BACKGROUND OF THE INVENTION

With the advent of modem telecommunications systems a variety of voice-based systems have been developed to reduce the costly and inefficient use of human operators. For example, a caller to a place of business may be routed to an interactive voice application via a computer telephony interface where spoken words from the caller may be recognized and processed in order to assist the caller with her needs. A typical voice application session includes a number of interactions between the user (caller) and the voice application system. The system may first play one or more voice prompts to the caller to which the caller may respond. A speech recognition engine recognizes spoken words from the caller and passes the recognized words to an appropriate voice application. For example, if the caller speaks “transfer me to Mr. Jones please,” the speech recognition engine must recognize the spoken words in order for the voice application, for example a voice-based call processing application, to transfer the caller as requested.

Unfortunately, given the vast number of spoken words comprising a given language and given the different voice inflections and accents used by different callers (users), often speech recognition engines incorrectly process spoken words and pass erroneous data to a given voice application. Following the example described above, speech recognition may receive the spoken words “Mr. Jones,” but the speech recognition engine may process the word as “Mr. Johns” which may result in the caller being transferred to the wrong party.

In prior systems, developers of speech recognition engines manually inspect speech recognition engine processing results for a given set of words or utterances. For each word or utterance the speech recognition engine has trouble recognizing, the developer must take corrective action. Unfortunately, with such systems, quality control is limited and often end users of the speech recognition engine are left to discover errors through use of the speech recognition engine.

Accordingly, there is a need for a method and system for automatically testing and improving the performance of a speech recognition system. It is with respect to these and other considerations that the present invention has been made.

### SUMMARY OF THE INVENTION

Embodiments of the present invention solve the above and other problems by providing a system and method for testing and improving the performance of a speech recognition system. According to one aspect of the invention a set of words, phrases or utterances are assembled for recognition by one or more speech recognition engines. Each word, phrase or utterance of a selected type is passed one word, phrase or utterance at a time by a vocabulary extractor application to a text-to-speech application. At the text-to-speech application, an audio pronunciation of each word, phrase or utterance is created. Each audio pronunciation is passed to one or more speech recognition engines for recognition. The speech recognition engine analyzes the audio pronunciation and derives one or more words, phrases or utterances from each audio pronunciation passed from the text-to-speech engine. The speech recognition engine next assigns a confidence score to each of the one or more words or utterances derived from the audio pronunciation based on how confident the speech recognition is that the derived words or utterances are correct.

If the confidence score for a given derived word, phrase or utterance exceeds an acceptable threshold, a determination is made that the speech recognition engine correctly recognized the word, phrase or utterance passed to it from the text-to-speech engine. If the confidence score is below the acceptable threshold, the results of the speech recognition engine for the word, phrase or utterance are passed to a developer. In response, the developer may take corrective action such as modifying the speech recognition engine, programming the speech recognition engine with a word, phrase or utterance to be associated with the audio pronunciation, modifying the acceptable confidence score threshold, and the like. Speech recognition engine results may be passed to the developer for one word, phrase or utterance at a time or in batch mode.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention, as claimed.

### BRIEF DESCRIPTION OF THE DRAWINGS

FIG. 1 is a simplified block diagram illustrating interaction between a wireless or wireline telephony system and an interactive voice system according to embodiments of the present invention.

FIG. 2 is a simplified block diagram illustrating interaction of software components according to embodiments of the present invention for identifying and correcting speech recognition system errors.

FIG. 3 illustrates a logical flow of steps performed by a method and system of the present invention for identifying and correcting speech recognition system errors.

### DETAILED DESCRIPTION OF THE PREFERRED EMBODIMENT

As briefly described above, embodiments of the present invention provide methods and systems for testing and improving the performance of a speech recognition system. The embodiments of the present invention described herein may be combined, other embodiments may be utilized, and structural changes may be made without departing from the spirit and scope of the present invention. The following detailed description is, therefore, not to be taken in the limiting sense, and the scope of the present invention is defined by the pending claims and their equivalents. Referring now to the drawings, in which like numerals refer to like components or like elements throughout the several figures, aspects of the present invention and an exemplary operating environment will be described.

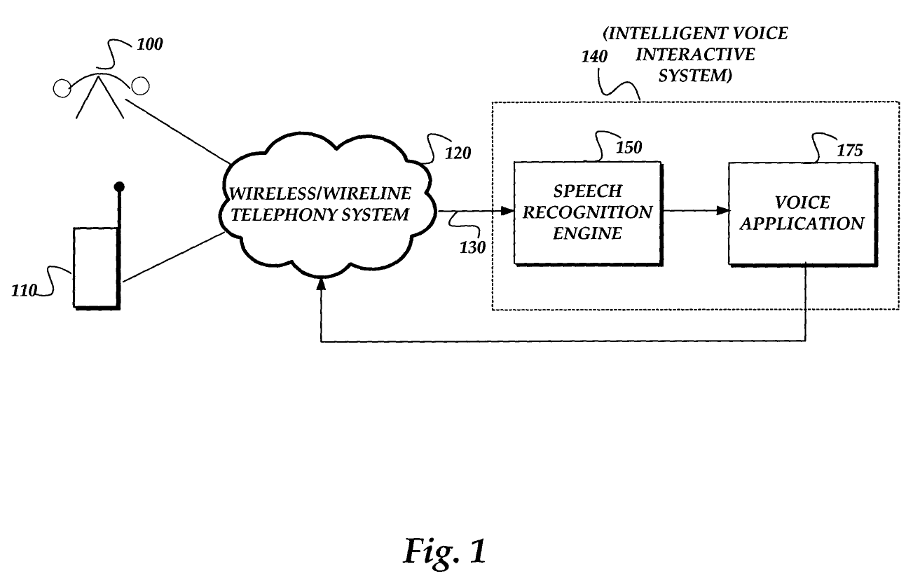

FIG. 1 and the following description are intended to provide a brief and general description of a suitable operating environment in which embodiments of the present invention may be implemented. FIG. 1 is a simplified block diagram illustrating interaction between a wireless or wireline telephony system and an interactive voice system according to embodiments of the present invention.

A typical operating environment for the present invention includes an interactive voice system 140 through which an interactive voice communication may be conducted between a human caller and a computer-implemented voice application 175. The interactive voice system 140 is illustrative of a system that may receive voice input from a caller and convert the voice input to data for processing by a general purpose computing system in order to provide service or assistance to a caller or user. Interactive voice systems 140 are typically found in association with wireless and wireline telephony systems 120 for providing a variety of services such as directory assistance services and general call processing services. Alternatively, interactive voice systems 140 may be maintained by a variety of other entities such as businesses, educational institutions, leisure activities centers, and the like for providing voice response assistance to callers. For example, a department store may operate an interactive voice system 140 for receiving calls from customers and for providing helpful information to customers based on voice responses by customers to prompts from the interactive voice system 140. For example, a customer may call the interactive voice system 140 of the department store and may be prompted with a statement such as “welcome to the department store—may I help you?” If the customer responds “please transfer me to the shoe department,” the interactive voice system 140 will attempt to recognize and process the statement made by the customer and transfer the customer to the desired department.

The interactive voice system 140 may be implemented with multi-purpose computing systems and memory storage devices for providing advanced voice-based telecommunications services as described herein. According to an embodiment of the present invention, the interactive voice system 140 may communicate with a wireless/wireline telephony system 120 via ISDN lines 130. The line 130 is also illustrative of a computer telephony interface through which voice prompts and voice responses may be passed to the general-purpose computing systems of the interactive voice system 140 from callers or users through the wireless/wireline telephony system 120. The interactive voice system also may include DTMF signal recognition devices, speech recognition, tone generation devices, text-to-speech (TTS) voice synthesis devices and other voice or data resources.

As illustrated in FIG. 1, a speech recognition engine 150 is provided for receiving voice input from a caller connected to the interactive voice system 140 via the wireless/wireline telephony system 120. According to embodiments of the present invention, if the voice input from the caller is analog, the telephony interface component in the interactive voice system converts the voice input to digital. Then, the speech recognition engine 150 analyzes and attempts to recognize the voice input. As understood by those skilled in the art, speech recognition engines use a variety of means for recognizing spoken utterances. For example, the speech recognition may analyze phonetically the spoken utterance passed to it to attempt to construct a digitized spelled word or phrase from the spoken utterance.

Once a voice input is recognized by the speech recognition engine, data representing the voice input may be processed by a voice application 175 operated by a general computing system. The voice application 175 is illustrative a variety of software applications containing sufficient computer executable instructions which when executed by a computer provide services to a caller or a user based on digitized voice input from the caller or user passed through the speech recognition engine 150.

In a typical operation, a voice input is received by the speech recognition engine 150 from a caller via the wireless/wireline telephony system 120 requesting some type of service, for example general call processing or other assistance. Once the initial request is received by the speech recognition engine 150 and is passed as data to the voice application 175, a series of prompts may be provided to the user or caller to request additional information from the user or caller. Each responsive voice input by the user or caller is recognized by the speech recognition engine 150 and is passed to the voice application 175 for processing according to the request or response from the user or caller. Canned responses to the caller may be provided by the voice application 175 or responses may be generated by the voice application 175 on the fly by obtaining responsive information from a memory storage device followed by a conversion of the responsive information from text-to-speech, followed by playing the text-to-speech response to the caller or user.

According to embodiments of the present invention, the interactive voice system 140 may be operated as part of an intelligent network component of a wireless and wireline telephony system 120. As is known to those skilled in the art, modem telecommunications networks include a variety of intelligent network components utilized by telecommunications services providers for providing advanced functionality to subscribers. For example, according to embodiments of the present invention the interactive voice system 140 may be integrated with a services node/voice services node (not shown) or voice mail system (not shown). Services nodes/voice services nodes are implemented with multi-purpose computing systems and memory storage devices for providing advanced telecommunications services to telecommunication services subscribers. In addition to the computing capability and database maintenance features, such services nodes/voice services nodes may include DTMF signal recognition devices, voice recognition devices, tone generation devices, text-to-speech (TTS), voice synthesis devices and other voice or data resources.

The interactive voice system 140 operating as a stand alone system, as illustrated in FIG. 1, or operating via an intelligent network component, such as a services node or a voice services node, may be implemented as a packet-based computing system for receiving packetized voice and data communications. Accordingly, the computing systems and software of the interactive voice system 140 or services nodes/voice services node may be communicated with via voice and data over Internet Protocol from a variety of digital data networks such as the Internet and from a variety of telephone and mobile digital devices 100, 110.

The wireless/wireline telephony system 120 is illustrative of a wired public switched telephone network accessible via a variety of wireline devices such as the wireline telephone 100. The telephony system 120 is also illustrative of a wireless network such as a cellular telecommunications network and may comprise a number of wireless network components such as mobile switching centers for connecting communications from wireless subscribers from wireless telephones 110 to a variety of terminating communications stations. As should be understood by those skilled in the art, the wireless/wireline telephony system 120 is also illustrative of other wireless connectivity systems including ultra wideband and satellite transmission and reception systems where the wireless telephone 110 or other mobile digital devices, such as personal digital assistants, may send and receive communications directly through varying range satellite transceivers.

As illustrated in FIG. 1, the telephony devices 100 and 110 may communicate with an interactive voice system 140 via the wireless/wireline telephony system 120. The telephones 100 and 110 may also connect through a digital data network such as the Internet via a wired connection or via wireless access points to allow voice and data communications. For purposes of the description that follows, communications to and from any wireline or wireless telephone unit 100, 110 includes, but is not limited to, telephone devices that may communicate via a variety of connectivity sources including wireline, wireless, voice and data over Internet protocol, wireless fidelity (WIFI), ultra wideband communications and satellite communications. Mobile digital devices, such as personal digital assistants, instant messaging devices, voice and data over Internet protocol devices, communication watches or any other devices allowing digital and/or analog communication over a variety of connectivity means may be utilized for communications via the wireless and wireline telephony system 120.

While the invention may be described in general context of software program modules that execute in conjunction with an application program that runs on an operating system of a computer, those skilled in the art will recognize that the invention may also be implemented in a combination of other program modules. Generally, program modules include routines, programs, components, data structures and other types of structures that perform particular tasks or implement particular abstract data types. Moreover, those skilled in the art will appreciate that the invention may be practiced with other telecommunications systems and computer systems configurations, including hand-held devices, multi-processor systems, multi-processor based or programmable consumer electronics, mini computers, mainframe computers, and the like. The invention may also be practiced in a distributed computing environment where tasks are performed by remote processing devices that are linked through a communications network. In a distributing computing environment, program modules may be located in both local and remote memory sources devices.

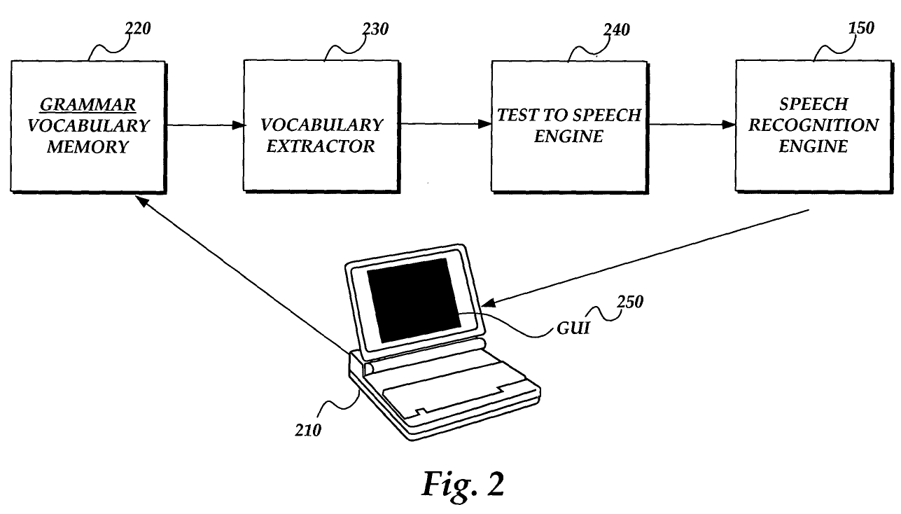

According to embodiments of the present invention, and as illustrated in FIG. 2, an automated process is described with which a developer of speech recognition applications may identify problems associated with a speech recognition engine's ability to recognize certain grammatical types and spoken words or phrases or utterances (hereafter “utterance). According to an embodiment of the present invention, a number of grammar types and spoken utterances may be entered into a grammar/vocabulary memory 220 by a developer using the developer's computer 210 for testing a speech recognition engine's ability to process spoken forms of those grammar types and utterances.

For example, a developer may wish to develop a speech recognition grammar for use by an auto-attendant system that will answer and route telephone calls placed to a business. In such a system, a calling party may call a business and be connected to an auto-attendant system operated through an interactive voice system 140 as described above. Based on one or more prompts provided to the caller, the caller may respond using a number of different spoken utterances such as “Mr. Jones please,” “Mr. Jones,” “extension 234,” “transfer me to Mr. Jones' cellular phone,” or “I would like to talk to Mr. Jones.” Such grammatical phrases and words are for purposes of example only as many additional types of utterances may be utilized by a caller in response to prompts by the interactive voice system operating the auto-attendant system to which the caller is connected.

In order to test and improve the performance of a speech recognition engine 150 to recognize the grammatical phrases and words uttered by the caller such as the example utterances provided above, each grammatical type and utterance is loaded by the developer into the grammar/vocabulary 220 using the developer's computer 210. According to an embodiment of the present invention, the grammatical types and utterances to be tested are categorized according to grammar-sub-trees. For example, names such as Mr. Jones may be categorized under a grammar sub-tree for people. Action phrases such as “transfer me to” and “I would like to talk to” may be categorized under a grammar sub-tree for actions. Utterances such as “please” may categorized under a grammar sub-tree for polite remarks including other remarks such as “thank you” “may I help you” and the like. Utterances such as “extension 234”, “office phone”, “cellular telephone” may be categorized under yet another grammar sub-tree for call transfer destinations. The various grammar sub-trees may be combined to form an overall grammar tree containing all spoken utterances that may be tested and/or understood by the speech recognition engine. By categorizing spoken utterances and words by grammar type, the application developer may test a speech recognition engine's ability to recognize and process particular types of utterances such as person names during one testing session.

According to embodiments of the present invention, once the developer selects a particular grammar sub-tree, such as people or person names, a vocabulary extractor module 230 extracts all words or utterances contained in the selected grammar sub-tree for testing by the speech recognition engine 150. The vocabulary extractor 230 passes the extracted words or utterances to a text-to-speech engine 240. The text-to-speech 240 converts each of the selected words or utterances from text to speech to provide an audio formatted pronunciation of the words or utterances to the speech recognition engine 150 for testing speech recognition engine's ability to recognize audio forms of the selected words or utterances. As should be understood, according to a manual process, a developer or other voice talent could be used to speak each of the words or utterances directly to the speech recognition engine 150 for testing speech recognition engine. Advantageously, embodiments of the present invention allow for automating the testing process by converting selected words or utterances from text to speech by a text-to-speech engine 240 for provision to the speech recognition engine 150.

As should be understood, the vocabulary extractor 230, the TTS engine 240 and the speech recognition engine 150 include software application programs containing sufficient computer executable instructions which when executed by a computer perform the functionality described herein. The components 230, 240, 150 and the memory location 220 may be included with the interactive voice system 140, described above, or these components may be operated via a remote computing system such as the user's computer 210 for testing the performance of a given speech recognition engine 150.

Once the speech recognition engine 150 receives the audio pronunciation of the words or utterances from the text-to-speech engine 240, the speech recognition engine 150 processes each individual word or utterance and returns one or more recognized words or utterances associated with a given audio pronunciation passed to the speech recognition engine. For example, if the name “Bob Jones” is converted from text to speech by the TTS engine 240 and is passed to the speech recognition engine 150, the speech recognition engine 150 may process the audio pronunciation of “Bob Jones” and return one or more recognized words or phrases such as “Bob Jones”, “Bob Johns”, “Rob Jones” and “Rob Johns.” According to one embodiment, the speech recognition engine breaks down the audio pronunciation passed to it by the TTS engine 240 and attempts to properly recognize the audio pronunciation. If the spoken words are “Bob Jones,” but the speech recognition engine recognizes the spoken words as “Rob Johns,” the caller may be transferred to the wrong party. Accordingly, methods and systems of the present invention may be utilized to identify such problems where the speech recognition engine 150 erroneously processes a spoken word or utterance and produces an incorrect result.

For each output of the recognition engine, the speech recognition engine provides a confidence score associated with the speech recognition engine's confidence that the output is a correct representation of the audio pronunciation received by the speech recognition engine. For example, the output “Bob Jones” may receive a confidence score of 65. The output “Bob Johns” may receive a confidence score of 50. The output “Rob Johns” may receive a confidence score of 30. As should be understood by those skilled in the art, speech recognition engines are developed from a large set of utterances. A speech recognition engine developer basically teaches the engine how each utterance is pronounced so that when the engine encounters a new word or utterance, the engine is most likely to perform correctly and with confidence. According to embodiments of the present invention, the speech recognition engine generates a confidence score for a word or utterance it recognizes based on the confidence it has in the recognized word or utterance based on the teaching it has received by the developer. For example, when a word or utterance is recognized by the engine that previously has been “taught” to the engine, a high confidence score may be generated. When a word or utterance has not been “taught” to the engine, but is made up of components that have been taught to the engine, a lower confidence score may be generated. When a word or utterance is made up of components not known to the engine, the engine may generate a recognition for the word or utterance, but a low confidence score may be generated.

Alternatively, confidence scores may be generated by the speech recognition engine 150 based on phonetic analysis of the audio pronunciation received by the speech recognition engine 150. Accordingly, a higher confidence score is issued by the speech recognition engine 150 for output most closely approximating the phonetic analysis of the audio input received by the speech recognition engine. Conversely, the speech recognition engine provides a lower confidence score for an output that least approximates the phonetic analysis of the audio input received by the speech recognition engine 150.

The developer of the speech recognition application may program the speech recognition engine 150 to automatically pass output that receives a confidence score above a specified high threshold. For example, the speech recognition engine 150 may be programmed to automatically pass any output receiving a confidence score above 60. On the other hand, the speech recognition engine 150 may be programmed to automatically fail any output receiving a confidence score below a set threshold, for example 45. If a given output from the speech recognition engine falls between the high and low threshold scores, an indication is thus received that the speech recognition engine is not confident that the output it produced from the audio input is correct or incorrect.

For such output data following between the high and low threshold scores, the developer may wish to analyze the output result to determine whether the speech recognition engine has a problem in recognizing the particular grammar type or utterance associated with the output. For example, if the correct input utterance is “Mr. Jones,” and the speech recognition engine produces an output of “Mr. Jones,” but provides a confidence score between the high and low threshold scores, an indication is thus received that the speech recognition engine has difficulty recognizing and processing the correct word. Likewise, if the correct phrase “Mr. Jones,” receives a confidence score from the speech recognition below the low threshold score, an indication is also received that the speech recognition engine has difficulty recognizing this particular phrase or wording.

The speech recognition engine 150 may output to the developer information associated with a given word, phrase, utterance, or list of words, phrases, utterances to allow the developer to resolve the problem. For example, the developer may receive a copy of the audio pronunciation presented to the speech recognition engine 150 by the TTS engine 240. The developer may receive each of the recognition results output by the speech recognition engine, for example “Bob Jones,” “Bob Johns,” etc. The developer may also receive the confidence scores for each output result and the associated threshold levels associated with each output result. The developer may receive the described information via a graphical user interface 250 at the user's computer 210. The developer may receive information for each word, phrase, or utterance tested one word, phrase or utterance at a time, or the developer may receive a batch report providing the above described information for all words phrases, or utterances failing to receive acceptable confidence scores.

In response to the information received by the developer, the developer may change certain parameters of the speech recognition engine 150 and rerun the process for any selected words, phrases, or utterances. For example, the developer may alter the pronunciation of a particular utterance by recording the developer's own voice or the voice of another voice talent selected by the developer to replace the output received from the TTS engine 240 in order to isolate any problems associated with the TTS 240. The developer may also increase or decrease pronunciation possibilities for a given word, phrase or utterance to prevent the speech recognition engine for erroneously producing an output based on an erroneous starting pronunciation. Additionally, the developer may change the high and low threshold score levels to cause the speech recognition engine to be more or less selective as to the outputs that are passed or failed by the speech recognition engine 150. As should be understood, the process may be repeated by the developer until the developer is satisfied that speech recognition engine 150 produces satisfactory output. As should be appreciated, the testing method and system described herein may be utilized to test the performance of a variety of different speech recognition engines 150 as a way of comparing the performance of one speech recognition engine to another speech recognition engine.

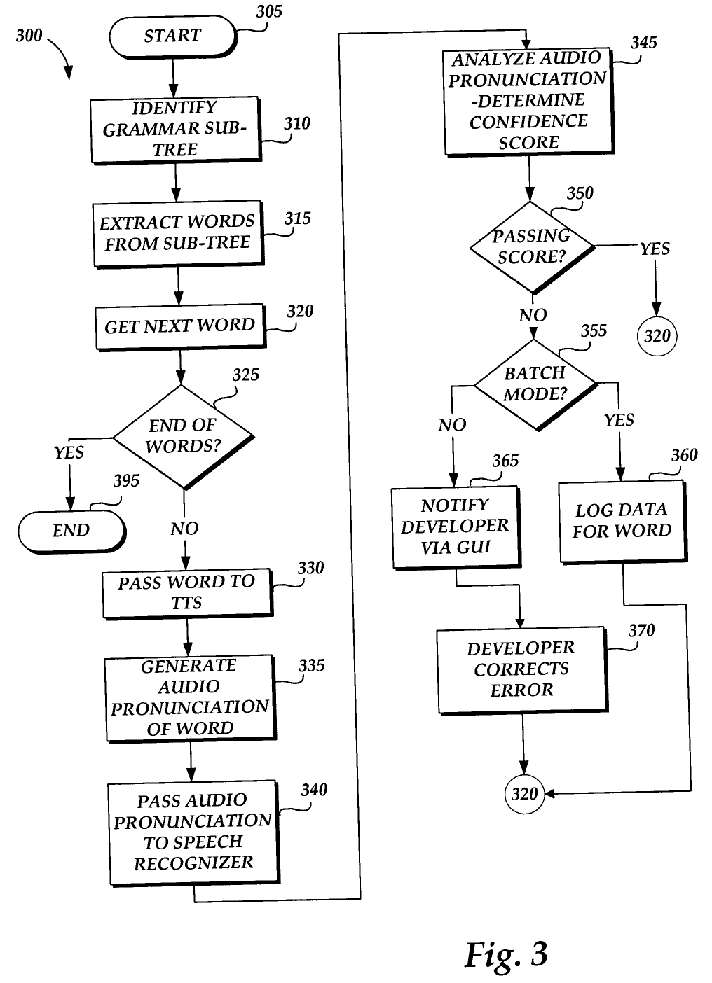

Having described an exemplary operating environment and architecture for embodiments for the present invention with respect to FIGS. 1 and 2 above, it is advantageous to describe embodiments of the present invention with respect to an exemplary flow of steps performed by a method and system of the present invention for testing and improving the performance of speech recognition engine. FIG. 3 illustrates a logical flow of steps performed by a method and system of the present invention for identifying and correcting speech recognition system errors.

The method 300 illustrated in FIG. 3 begins at start block 305 and proceeds to block 310 where a speech recognition application developer identifies and selects a particular grammar sub-tree such as a sub-tree containing person names whereby the developer desires to test a performance of a selected speech recognition engine 150. As described above with reference to FIG. 2, the words, phrases or utterances of the selected grammar sub-tree are loaded by the developer into a grammar/vocabulary memory location 220.

At block 315, the vocabulary extractor 230 extracts all words, phrases or utterances contained in the selected grammar sub-tree for analysis by the speech recognition engine 150. At block 320, vocabulary extractor 230 obtains the first word phrase or utterance for testing by the speech recognition engine 150. At step 325, a determination is made as to whether all words phrases or utterances contained in the grammar sub-tree have been tested. If so, the method ends at block 395. If not, the first selected word is passed by the vocabulary extractor 230 to the TTS engine 240. At block 335, the TTS engine 240 generates an audio pronunciation of the first selected utterance. At block 340, the audio pronunciation generated by the TTS engine 240 is passed to the speech recognition engine 150.

At block 345, the speech recognition engine 150 analyzes the audio pronunciation received by the TTS engine 240 and generates one or more digitized outputs for the audio pronunciation received by the speech recognition engine 150. For each output generated by the speech recognition engine 150, the speech recognition engine 150 generates a confidence score based on a phonetic analysis of the audio pronunciation received from the TTS engine 240.

At block 350, for each output received by the speech engine 150, a determination is made as to whether the confidence score provided by the speech recognition engine 150 exceeds a passing threshold level. If so, that output is identified as acceptable, and no notification to the developer is required for that output. For example, if the correct word or phrase passed to the TTS engine 240 from the vocabulary extractor is “Mr. Jones,” and output of “Mr. Jones” is received from the speech recognition engine with a confidence score exceeding the acceptable confidence score threshold, the output of “Mr. Jones” is designated as acceptable and no notification is reported to the developer for additional testing or corrective procedure in association with that output. On the other hand, if a given output receives a confidence score between the high and low confidence score threshold levels or below the low threshold score levels, the method proceeds to block 355.

At block 355, a determination is made as to whether the developer has designated that all output results will be reported to the developer in batch mode. If so, the method proceeds to block 360, and the output, confidence score, and other related information associated with the tested word, phrase or utterance is logged for future analysis by the developer. The method then proceeds back to block 320 for analysis of the next word, phrase or utterance from the grammar sub-tree.

Referring back to block 355, if the developer has designated that he/she desires notification of each utterance not passing or otherwise failing output one output at a time, the method proceeds to block 365, and the developer is notified of the output, confidence score, and other related information, described above, via the graphical user interface 250 presented to the developer via the developer's computer 210. At block 370, the developer may take corrective action, as described above, to alter or otherwise improve the performance of the speech recognition engine in recognizing the word, phrase or utterance tested by the speech recognition engine. The method then proceeds back to block 320, and the next word, phrase or utterance in the grammar sub-tree is tested, as described herein.

As described, an automated process for testing and improving the performance of a speech recognition engine is provided. It will be apparent to those skilled in the art that various modifications or variations may be made in the present invention without departing from the scope or spirit of the invention. Other embodiments of the invention will be apparent to those skilled in the art from consideration of this specification and from practice of the invention disclosed herein.

1. A method for testing and improving the performance of a speech recognition engine, comprising:
identifying one or more words, phrases or utterances for recognition by a speech recognition engine;
passing the one or more identified words, phrases or utterances to a text-to-speech conversion module;
passing an audio pronunciation of each of the identified one or more words, phrases or utterances from the text-to-speech conversion module to the speech recognition engine;
creating a recognized word, phrase or utterance for each audio pronunciation passed to the speech recognition engine; and
analyzing each recognized word, phrase or utterance to determine how closely each recognized word, phrase or utterance approximates the respective audio pronunciation from which each recognized word, phrase or utterance is derived.

2. The method of claim 1, further comprising assigning a confidence score to each recognized word, phrase or utterance.

3. The method of claim 2, whereby assigning the confidence score to each recognized word, phrase or utterance is based on a confidence level associated with the each recognized word, phase or utterance based on prior speech recognition engine training.

4. The method of claim 3, whereby assigning the confidence score to each recognized word, phrase or utterance is based on a confidence with which the speech recognition engine determines that each recognized word, phrase or utterance is the same as each respective word, phrase or utterance from which each recognized word, phrase or utterance is derived by the speech recognition engine based on prior speech recognition engine training.

5. The method of claim 2, whereby if the confidence score exceeds an acceptable confidence score threshold level, designating the recognized word, phrase or utterance associated with the confidence score as being accurately recognized by the speech recognition engine.

6. The method of claim 5, whereby if the confidence score is less than an acceptable threshold, modifying the speech recognition engine to recognize the word, phrase or utterance from which the recognized word, phrase or utterance is derived with higher accuracy.

7. The method of claim 5, whereby if the confidence score is less than an acceptable confidence score threshold level, notifying a speech recognition engine developer.

8. The method of claim 6, whereby modifying the speech recognition engine includes altering the audio pronunciation of the word, phrase or utterance associated with the confidence score that is less than an acceptable confidence score threshold level such that the altered audio pronunciation obtains an acceptable confidence score upon a next pass through the speech recognition engine.

9. The method of claim 6, whereby modifying the speech recognition engine includes reducing the acceptable confidence score threshold level.

10. The method of claim 1, after analyzing each recognized word, phrase or utterance, determining whether each recognized word, phrase or utterance is the same as a respective word, phrase or utterance from which the recognized word, phrase or utterance is derived.

11. The method of claim 10, whereby if any recognized word, phrase or utterance is the same as the respective word, phrase or utterance from which the any recognized word, phrase or utterance is derived, designating the any recognized word, phrase or utterance as being accurately recognized by the speech recognition engine.

12. The method of claim 1, prior to identifying one or more words, phrases or utterances for recognition by a speech recognition engine, loading into a memory location the one or more words, phrases or utterances.

13. The method of claim 12, further comprising extracting the one or more words, phrases or utterances via a vocabulary extractor module.

14. The method of claim 12, further comprising categorizing the one or more words, phrases or utterances by grammar type whereby all words, phrases or utterances of a same grammar type are grouped together in a grammar sub-tree.

15. The method of claim 12, whereby a plurality of grammar sub-trees are grouped together to form a grammar tree containing all of the one or more words, phrases or utterances.

16. The method of claim 14, whereby identifying one or more words, phrases or utterances for recognition by the speech recognition engine includes identifying a grammar sub-tree containing the one or more words, phrases or utterances.

17. The method of claim 1, whereby creating a recognized word, phrase or utterance for each respective audio pronunciation includes converting each respective audio pronunciation from an audio format to a digital format by the speech recognition engine; and
analyzing phonetically each audio pronunciation of each of the one or more words, phrases or utterances to create the recognized word, phrase or utterance for each respective audio pronunciation.

18. A system for testing and improving the performance of a speech recognition engine, comprising:
a text-to-speech conversion module operative
to receive one or more identified words, phrases or utterances;
to create and to pass an audio pronunciation of each of the identified one or more words, phrases or utterances the speech recognition engine;
the speech recognition engine operative
to create a recognized word, phrase or utterance for each audio pronunciation; and
to analyze each recognized word, phrase or utterance to determine how closely each recognized word, phrase or utterance approximates the respective audio pronunciation from which each recognized word, phrase or utterance is derived.

19. The system of claim 18, whereby the speech recognition engine is further operative to assign a confidence score to each recognized word, phrase or utterance by analyzing each recognized word, phrase or utterance to determine how closely each recognized word, phrase or utterance approximates the respective audio pronunciation of each of one or more words, phrase, utterances.

20. The system of claim 19, whereby the speech recognition engine is further operative to send a notification to a speech recognition engine developer if the confidence score is less than an acceptable confidence score threshold level.

21. The system of claim 20, further comprising:
a vocabulary extractor module operative
to extract the identified one or more words, phrases or utterances from a memory location; and
to pass each extracted word, phrase or utterance to the text-to-speech conversion module.

22. A method for testing and improving the performance of a speech recognition engine, comprising:
identifying one or more words, phrases or utterances for recognition by a speech recognition engine;
creating and passing an audio pronunciation of each of the identified one or more words, phrases or utterances from a text-to-speech conversion module to the speech recognition engine;
deriving a recognized word, phrase or utterance for each audio pronunciation passed to the speech recognition engine;
assigning a confidence score to each recognized word, phrase or utterance based on the speech recognition engine's confidence in each recognized word, phrase or utterance based on prior training of the speech recognition engine to recognize similar or same words, phrases or utterances as the each recognized word, phrase or utterance; and
if the confidence score is less than an acceptable threshold, modifying the speech recognition engine to recognize the word, phrase or utterance from which the recognized word, phrase or utterance is derived with higher accuracy.

23. The method of claim 22, whereby modifying the speech recognition engine includes altering the audio pronunciation of the word, phrase or utterance associated with the confidence score that is less than an acceptable confidence score threshold level such that the altered audio pronunciation obtains an acceptable confidence score upon a next pass through the speech recognition engine.

24. The method of claim 22, whereby modifying the speech recognition engine includes reducing the acceptable confidence score threshold level.
